(19) United States
(12) Patent Application Publication
(10) Pub. No.: US 2024/0307813 A1
(43) Pub. Date: Sep. 19, 2024

(54) METHODS AND SYSTEMS FOR THE REMOVAL OF IMPURITIES IN A FLUE GAS

(71) Applicant: CARBON CLEAN SOLUTIONS LIMITED, London (GB)

(72) Inventors: Prateek BUMB, London (GB); Gopi Kiran NEELIESETTY, Bangalore (IN); Ausula Ramesh KUMAR, Mumbai Maharastra (IN)

(21) Appl. No.: 18/571,136

(22) PCT Filed: Jun. 13, 2022
(86) PCT No.: PCT/GB2022/051482

§ 371 Date: Dec. 15, 2023

(30) Foreign Application Priority Data
Jun. 15, 2021 (IN) 202111026542

(51) Int. Cl. B01D 53/14; B01D 53/00; B01D 53/18; B01D 53/50; B01D 53/56; B01D 53/60; B01D 53/62; B01D 53/75; B01D 53/78

(52) U.S. Cl. CPC B01D 53/1406; B01D 53/002; B01D 53/1475; B01D 53/1481; B01D 53/1493; B01D 53/18; B01D 53/502; B01D 53/56; B01D 53/60; B01D 53/62; B01D 53/75; B01D 53/78; B01D 2251/304; B01D 2251/606; B01D 2252/204; B01D 2257/302; B01D 2257/404; B01D 2257/504; B01D 2258/0283

(57) ABSTRACT

The present invention relates to a method and a system for the removal of impurities from a flue gas. In particular, the present invention relates to a method and a system for the removal of impurities such as SO₃ (acid mist), SO₂ (sulphur dioxide), NO₂ (nitrogen dioxide) from a CO₂ (carbon dioxide) rich flue gas.

### FIELD OF THE INVENTION

The present invention relates to methods and systems for the removal of impurities from a flue gas. In particular, the present invention relates to methods and systems for the removal of impurities such as SO₃ (sulphur trioxide; which can form acid mist), SO₂ (sulphur dioxide) and/or NO₂ (nitrogen dioxide) from a CO₂ (carbon dioxide) rich flue gas.

### BACKGROUND OF THE INVENTION

Flue gases from power plants and other industrial activities include pollutants, for example greenhouse gases. One such greenhouse gas is CO₂ (carbon dioxide).

Emissions of CO₂ to the atmosphere from industrial activities are of increasing concern to society and are therefore becoming increasingly regulated.

To reduce the amount of CO₂ released into the atmosphere, CO₂ capture technology can be applied. The selective capture of CO₂ allows CO₂ to be re-used or geographically sequestered.

The selective capture of CO₂ from a flue gas is sometimes called post-combustion recovery. In post-combustion recovery, CO₂ from the flue gas is selectively separated from nitrogen and oxygen (and other gases) by contacting a flue gas with a suitable solvent (for example a carbon capture solvent), for example in an absorber.

Prior to post-combustion recovery, the concentration of impurities in the flue gas is often reduced. Impurities include SO₂ (sulphur dioxide), SO₃ (sulphur trioxide; which can form acid mist) and NO₂ (nitrogen dioxide). Impurities are formed by the combustion of fuels, for example burning coals containing sulphur produces SO₂ in a flue gas.

Ideally, the level of impurities is reduced to less than 10 ppmv (parts per million by volume), or less than 2 ppmv.

If the concentration of impurities in the flue gas is not reduced prior to contacting the flue gas with a carbon capture solvent, the degradation, loss and/or damage of the carbon capture solvent is accelerated.

Traditional flue gas desulphurisation (FGD) techniques do not have the capability to decrease the concentration of impurities to less than 10 ppmv, preferably less than 2 ppmv. Reducing the impurities in the flue gas to less than 10 ppmv, preferably less than 2 ppmv, prior to contact with a carbon capture solvent, serves to maximise the efficiency of the carbon capture solvent and maximise the length of time the carbon capture solvent can be used.

Degradation of the solvent (for example a carbon capture solvent) used in an absorber results in a reduction in CO₂ captured from the flue gas and an increased need for solvent replacement or regeneration. Impurities such as SO₃ (which can form acid mist) present in the flue gas result in an increase of solvent emissions which cannot be recovered using conventional methods. Hence, a reduction in the concentration of impurities in the flue gas is beneficial to maximise the efficiency of carbon capture processes and systems.

Degradation and vapor emissions of a carbon capture solvent are both accelerated through the presence of acid mist, for example SO₃ acid mist. Acid mist is formed in a boiler or a wet flue gas desulphurisation vessel when the temperature of a flue gas drops below the dew point of SO₃. At these temperatures, SO₃ condenses either as small fog droplets resulting in the formation of acid mist, and/or as a film on the walls of a flue gas duct or direct contact cooling tower. Furthermore, if the SO₃ has not condensed, the droplets of SO₃ can easily form aerosols in the flue gas resulting in the formation of an acid mist.

The acid mist formed is carried away with the flue gas due to the nanometre size of the aerosol in the flue gas system, and consequently the acid mist can enter the carbon capture system. If the acid mist enters a carbon capture absorber and contacts a carbon capture solvent, the acid mist will be able to carry solvent out of the carbon capture absorber resulting in: (a) loss of solvent; and, (b) emissions containing solvent and SO₃.

Further consequences that arise if the concentration of impurities in the flue gas are not reduced include: (a) a need for continuous supplementation of the carbon capture solvent used in the absorber to ensure that the amount of CO₂ removed from the flue gas is not reduced; and, (b) treating the flue gas post removal of the CO₂, and in particular aerosols present in the flue gas post removal of the CO₂, to ensure the flue gas meets with environmental regulations. To ensure the lowest CO₂ capture cost ($/ton) is achieved, both consequences described above are significant and need consideration.

WO2009003238A1 discloses a process for removing carbon dioxide from a flue gas, wherein the process can include cooling the flue gas to below 50° C. by contacting the flue gas with a counter current stream of liquid water and removing the carbon dioxide by directly contacting the flue gas with a scrubbing agent, wherein the scrubbing agent can be an amine or methanol.

WO2020159868A1 discloses methods for sequestering CO₂, NO_{X} and SO₂. The gases are then converted into products including sodium bicarbonate and sodium nitrate.

FIG. 1 illustrates a known system 100 used in the removal of CO₂ from a flue gas.

A flue gas 101 enters the system 100 and passes through a flue gas blower 102.

The flue gas blower 102 increases the pressure of the flue gas 101 to compensate for the pressure drop through the CO₂ removal system (i.e. system 100 and the downstream carbon capture system, not shown), thereby ensuring that the pressure of the flue gas 101 once cooled (cooled flue gas 109) is at the same, or a similar, pressure as a flue gas at the outlet of the downstream carbon capture system (not shown). Typically, the flue gas blower 102 can be an induced draft fan, optionally provided at the battery limit.

The flue gas 101 enters the system 100 at a temperature of from 115° C. to 200° C. This temperature is above the dew point temperature of SO₃. Before the flue gas 101 can come into contact with a carbon capture solvent in an absorber, the temperature of the flue gas 101 has to be reduced. Therefore, the flue gas 101 passes through a direct contact cooling tower 103 to reduce the temperature further to 50° C., or preferably 40° C.

In the direct contact cooling tower 103, flue gas 101 is contacted with cool circulating water 104 (at approximately 40° C.) in a counter-current direction. Heat from the flue gas 101 is transferred to the cool water 104, forming heated water 105. The heated water 105 is recirculated through a cooler 106 to reduce the temperature of the heated water 105 so that the heated water 105 can be converted into cool water 104, ready for re-use in the direct contact cooling tower 103. Water is moved through the direct contact cooling tower 103 and cooler 106 by a pump 107. Non-useable water and any condensed moisture from the flue gas 101 are removed from the cycle by a drain 108.

The level of condensed water in the direct contact cooling tower 103 is controlled via a bleed line (not shown).

The direct contact cooling tower 103 can be a packed bed tower.

The water circulating in the direct contact tower 103 and cooler 106 can be demineralised water (DM water).

The cooler 106 cools the heated water 105 by using a cooling medium comprising sea water, or, cooling water from a cooling tower, or, cool air present in or around the cooler 106.

Upon cooling, the flue gas 101 forms cooled flue gas 109. The temperature of the cooled flue gas is approximately 50° C. or below, typically 40° C.

The cooled flue gas 109 then passes to an impurities removal tower 110. The impurities removal tower 110 can additionally include a cooler 111, a circulation pump 112, filters (not shown), a dosing pump (not shown) and/or a scrubbing solution tank (not shown).

The impurities removal tower 110 can be a packed column which enables efficient gas-liquid contact.

A scrubbing solution is prepared in the scrubbing solution tank (not shown) and can be re-circulated through the impurities removal tower 110. The scrubbing solution contains scrubbing agents which react with, and subsequently remove, impurities in the flue gas. Typically, the scrubbing agent is caustic soda (NaOH) in water, and is used for removal of SO₂ from flue gases.

A dosing pump (not shown) can be used to make-up the scrubbing solution based on the pH of the scrubbing solution, which reduces when the scrubbing solution reacts with the impurities.

Within the impurities removal tower 110, the cooled flue gas 109 is contacted with the scrubbing solution so that the concentration of impurities within the cooled flue gas 109 is reduced to 10 ppmv or below.

The temperature of the impurities removal tower 110 is maintained by a cooler 111.

The scrubbing solution is moved through the impurities removal tower 110 and the cooler 111 by the pump 112. Any waste created is removed via line 113 to be sent to an Effluent Treatment Plant (FTP) for treatment before disposal.

The cooled, impurity low flue gas 114 then passes to a downstream carbon capture system (not shown) for removal of CO₂.

In the known system 100 illustrated in FIG. 1, at least the following problems are encountered occur:
i. High levels of acid mist can form in the direct contact cooling tower 103 as a result of a sudden change in temperature of the flue gas 101 and the presence of SO₃ in the flue gas, which leads to carbon capture solvent degradation and solvent emissions as a result of the acid mist present in the downstream carbon capture system.
ii. Low removal efficiency of SO₂ and/or NO₂ (from the use of conventional scrubbing agents in the impurities removal tower 110).
iii. High space requirements for at least one additional tower/column, prior to contact with a carbon capture solvent.

Consequently, there is a need for a method and a system to remove SO₃ from the flue gas to reduce acid mist formation in the direct contact cooling tower.

Furthermore, there is a need for a method and a system to reduce the concentration of impurities, such as SO₂ and/or NO₂, in a flue gas.

Furthermore, there is a need for a low cost CO₂ capture method and system for reducing the concentration of impurities in a flue gas.

### SUMMARY OF THE INVENTION

The present invention relates to a method and a system for reducing the concentration of impurities in a flue gas.

Representative features of the present invention are set out in the following clauses, which stand alone or may be combined, in any combination, with one or more features disclosed in the text and/or figures of the specification.

The present invention is as set out in the following clauses:

1. A process of capturing carbon dioxide (CO₂) from flue gases, the process comprising the steps of:
(i) indirectly cooling a flue gas comprising carbon dioxide (CO₂), the flue gas having a starting temperature of from 115° C. to 200° C., to form a cooled flue gas having a cooled temperature of less than 95° C.;
(ii) indirectly or directly further cooling the cooled flue gas to between 37° C. and 50° C. to form a further cooled flue gas; prior to,
(iii) contacting the further cooled flue gas with a carbon capture solvent such that the carbon capture solvent removes carbon dioxide (CO₂) from the cooled flue gas.

2. The process of clause 1, wherein the step of (i) indirectly cooling occurs in a heat exchanger.

3. The process of clause 1 or clause 2, wherein the step of (i) indirectly cooling occurs in:
a spiral heat exchanger,
a shell and tube heat exchanger,
an air cooled heat exchanger, and/or,
a gas-gas heat exchanger.

4. The process of any one of clauses 1 to 3, wherein the step of (ii) indirectly further cooling occurs in a heat exchanger.

5. The process of any one of clauses 1 to 4, wherein the step of (ii) indirectly further cooling occurs in:
a spiral heat exchanger,
a shell and tube heat exchanger,
an air cooled heat exchanger, and/or,
a gas-gas heat exchanger.

6. The process of any one of clauses 1 to 3, wherein the step of (ii) directly further cooling occurs in a direct contact cooling tower.

7. The process of any one of clauses 1 to 6, wherein the process further comprises the steps of:
(iv) contacting a flue gas comprising carbon dioxide (CO₂) with a scrubbing agent, thereby removing SO₂ and NO₂ from the flue gas, to form a scrubbed flue gas; prior to,
(v) contacting the scrubbed flue gas comprising carbon dioxide (CO₂) with a carbon capture solvent such that the carbon capture solvent absorbs carbon dioxide (CO₂) from the scrubbed flue gas;
wherein the scrubbing agent comprises: sodium bicarbonate; or, sodium carbonate; or, sodium bicarbonate and sodium carbonate.

8. A system for capturing carbon dioxide (CO₂) from flue gases, the system comprising:
(i) an indirect contact cooler for cooling a flue gas comprising carbon dioxide (CO₂), the flue gas having a starting temperature of from 115° C. to 200° C., to form a cooled flue gas having a cooled temperature of less than 95° C.;
(ii) a cooler for indirectly or directly further cooling the cooled flue gas to between 37° C. and 50° C. to form a further cooled flue gas; and
(iii) a carbon capture system for contacting the further cooled flue gas with a carbon capture solvent such that the carbon capture solvent removes carbon dioxide (CO₂) from the cooled flue gas.

9. The system of clause 8, wherein the indirect contact cooler (i) is a heat exchanger.

10. The system of clause 8 or clause 9, wherein the indirect contact cooler (i) is:
a spiral heat exchanger,
a shell and tube heat exchanger,
an air cooled heat exchanger, and/or,
a gas-gas heat exchanger.

11. The system of any one of clauses 8 to 10, wherein cooler (ii) is a heat exchanger.

12. The system of any one of clauses 8 to 11, wherein the cooler (ii) is:
a spiral heat exchanger,
a shell and tube heat exchanger,
an air cooled heat exchanger, and/or,
a gas-gas heat exchanger.

13. The system of any one of clauses 8 to 12, wherein the cooler (ii) is a direct contact cooling tower.

14. The system of any one of clauses 8 to 13, wherein the system further comprises:
(iv) an impurities removal tower comprising a scrubbing solution for contacting a flue gas comprising carbon dioxide (CO₂) with a scrubbing agent, thereby removing SO₂ and NO₂ from the flue gas, to form a scrubbed flue gas; prior to,
(v) a carbon capture system for contacting the scrubbed flue gas comprising carbon dioxide (CO₂) with a carbon capture solvent such that the carbon capture solvent absorbs carbon dioxide (CO₂) from the scrubbed flue gas;
wherein the scrubbing agent comprises: sodium bicarbonate; or, sodium carbonate; or, sodium bicarbonate and sodium carbonate.

15. A process of capturing carbon dioxide (CO₂) from flue gases, the process comprising the steps of:
(i) contacting a flue gas comprising carbon dioxide (CO₂) with a scrubbing agent, thereby removing SO₂ and NO₂ from the flue gas, to form a scrubbed flue gas; prior to,
(ii) contacting the scrubbed flue gas comprising carbon dioxide (CO₂) with a carbon capture solvent such that the carbon capture solvent absorbs carbon dioxide (CO₂) from the scrubbed flue gas;
wherein the scrubbing agent comprises: sodium bicarbonate; or, sodium carbonate; or, sodium bicarbonate and sodium carbonate.

16. The process of clause 15, wherein: the sodium bicarbonate; or, the sodium carbonate; or, the sodium bicarbonate and sodium carbonate; is/are present in from 2% by weight to 10% by weight in the scrubbing agent.

17. The process of clause 15 or clause 16, wherein the process further comprises the steps of:
(iii) indirectly cooling a flue gas comprising carbon dioxide (CO₂), the flue gas having a starting temperature of from 200° C. to 115° C., to form a cooled flue gas having a cooled temperature of less than 95° C.;
(iv) indirectly or directly further cooling the cooled flue gas to between 37° C. and 50° C. to form a further cooled flue gas; prior to,
(v) contacting the further cooled flue gas with a carbon capture solvent such that the carbon capture solvent absorbs carbon dioxide (CO₂) from the cooled flue gas.

18. A system for capturing carbon dioxide (CO₂) from flue gases, the system comprising:
(i) an impurities removal tower comprising a scrubbing solution for contacting a flue gas comprising carbon dioxide (CO₂) with a scrubbing agent, thereby removing SO₂ and NO₂ from the flue gas, to form a scrubbed flue gas; prior to,
(ii) a carbon capture system for contacting the scrubbed flue gas comprising carbon dioxide (CO₂) with a carbon capture solvent such that the carbon capture solvent absorbs carbon dioxide (CO₂) from the scrubbed flue gas;
wherein the scrubbing agent comprises: sodium bicarbonate; or, sodium carbonate; or, sodium bicarbonate and sodium carbonate.

19. The system of clause 18, wherein the sodium bicarbonate; or, the sodium carbonate; or, the sodium bicarbonate and sodium carbonate; is/are present in from 2% by weight to 10% by weight in the scrubbing agent.

20. A scrubbing agent for removing NO₂, SO₂, or NO₂ and SO₂, from a flue gas, the scrubbing agent comprising:
sodium bicarbonate;
sodium carbonate; and,
water.

21. The scrubbing agent of clause 20, wherein the scrubbing agent comprises (in weight %):

| | |
|---|---|
| from 0.5 to 10.0 | sodium bicarbonate; |
| from 0.5 to 10.0 | sodium carbonate; and, |
| from 99.0 to 80.0 | water. |

22. The scrubbing agent of clause 20 or clause 21, wherein the scrubbing agent comprises (in weight %):

| | |
|---|---|
| from 1.0 to 5.0 | sodium bicarbonate; |
| from 1.0 to 5.0 | sodium carbonate; and, |
| from 98.0 to 90.0 | water. |

23. The scrubbing agent of any one of clauses 20 to 22, wherein the scrubbing agent comprises (in weight %):

| | |
|---|---|
| from 1.0 to 3.0 | sodium bicarbonate; |
| from 1.0 to 2.0 | sodium carbonate; and, |
| from 98.0 to 95.0 | water. |

24. Use of the scrubbing agent of any one of clauses 20 to 23 in a process according to any one of clauses 7, or 15 to 17.

### BRIEF DESCRIPTION OF THE FIGURES

Embodiments and examples of the invention are described below with reference to the accompanying drawings. The accompanying drawings illustrate various embodiments of systems, methods, and embodiments of various other aspects of the disclosure. Any person with ordinary skill in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is a block diagram of a prior art system used to reduce the concentration of impurities in a flue gas.

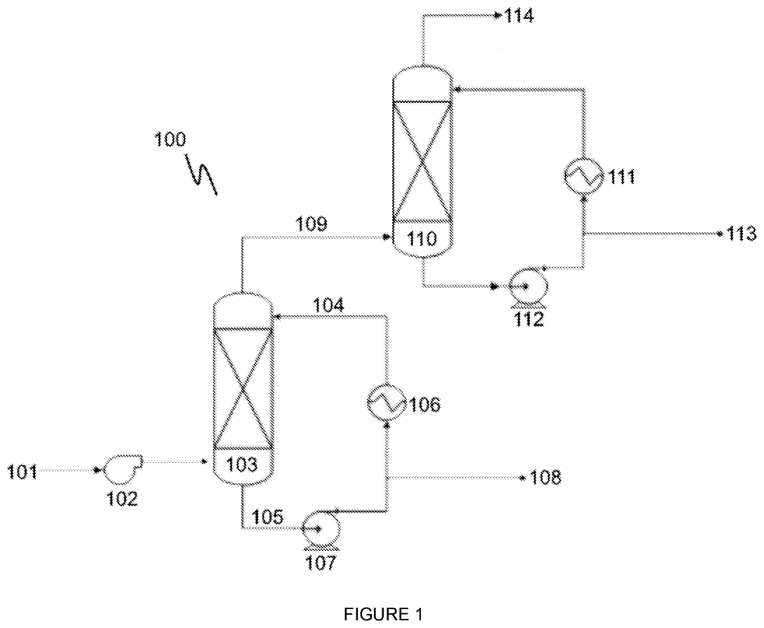

FIG. 2 is a block diagram of a system used to reduce the concentration of impurities in a flue gas by using an external cooling system to cool the flue gas.

FIG. 3 illustrates the process of indirect cooling compared to direct cooling.

FIG. 4 illustrates a block diagram of a system used to reduce the concentration of impurities in a flue gas through application of scrubbing agents.

FIG. 5 illustrates a block diagram of a system used to reduce the concentration of impurities in a flue gas by using an external cooling system to cool the flue gas and through application of scrubbing agents.

FIG. 6 is a graph showing the dew point temperature (° C.) as a function of SO₃ concentration (ppmv) in four flue gases, each having a different water concentration.

FIG. 7 is a graph showing the relationship between temperature and amine emissions for eight flue gases, each having a different SO₃ concentration.

### DETAILED DESCRIPTION OF THE INVENTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein.

Some of the terms used to describe the present invention are set out below:

“Absorber” refers to a part of a carbon capture system where components of a solvent (CO₂ lean solvent) uptake CO₂ from the gas phase to the liquid phase to form a CO₂ rich solvent. An absorber column contains trays or packing (random or structured), which provide a transfer area and intimate gas-liquid contact. The absorber column may be a static column or a Rotary Packed Bed (RPB). An absorber column typically functions, in use, for example at a pressure of from 1 bar to 30 bar.

“CO₂ lean solvent” refers to solvent with a relatively low concentration of carbon dioxide. In a carbon dioxide capture method, a CO₂ lean solvent for contact with flue gases typically has a concentration of carbon dioxide from 0.0 to 0.7 mol L⁻¹.

“CO₂ rich solvent” refers to a solvent with a relatively high concentration of carbon dioxide. In a carbon dioxide capture method, the 02 rich solvent after contact with flue gases typically has a concentration of carbon dioxide of from 2 to 3.3 mol L⁻¹.

“Dew point” refers to the temperature at which air is cooled to become saturated with water vapour. When cooled below the dew point, airborne water vapour condenses to form liquid water (this is called dew, i.e. aerosolised water).

“Direct contact cooling” refers to a part of a carbon capture system where a CO₂ rich flue gas is cooled. The process allows direct contact for cooling down a hot substance, typically a hot flue gas, with a cooling medium, typically a water stream. Typically, the hot substance and cooling medium move in opposite directions in direct contact so that heat passes from the hot substance to the cooling medium.

Typically, a CO₂ rich flue gas enters a direct contact cooling mechanism at a temperature of from 100° C. to 230° C., and is cooled to a temperature of less than 70° C.

“Flue gas” refers to a gas exiting to the atmosphere via a pipe or channel that acts as an exhaust from a boiler, furnace or a similar environment, for example a flue gas may be the emissions from power plants and other industrial activities that burn hydrocarbon fuel such as coal, gas and oil fired power plants, combined cycle power plants, coal gasification, hydrogen plants, biogas plants and waste to energy plants. Typically, the flue gas contains carbon dioxide. A “carbon dioxide rich flue gas” refers to a flue gas comprising carbon dioxide from 2.5 volume % to 51 volume %. A “carbon dioxide lean flue gas” refers to a flue gas comprising carbon dioxide below 2.5 volume weight %.

“Indirect contact cooling” refers to a part of a carbon capture system where a CO₂ rich flue gas is cooled indirectly. The process allows indirect contact for cooling down a hot substance, typically a hot flue gas, with a cooling medium, typically a liquid, and/or, an air stream. Typically, the cooling medium is water. The hot substance (for example a hot flue gas) travels through a pipe or conduit and the cooling medium travels through a separate set of piping or a conduit located around the pipe or the conduit containing the hot substance. Heat from the hot substance (typically a hot flue gas) can pass to the cooling medium. The separate set of piping in which the cooling medium travels can follow a tortuous path. Non-limiting examples of indirect contact cooling systems include spiral heat exchangers, shell and tube heat exchangers, air cooling heat exchangers and gas-gas heat exchangers. Typically, a hot CO₂ rich flue gas enters an indirect contact cooling system at a temperature of from 100° C. to 230° C., and is cooled to a temperature of less than 100° C. (which is below the acid dew point).

“Post-combustion recovery” refers to a process of selectively capturing CO₂ from a flue gas.

“Solvent” refers to an absorbent. The solvent may be liquid. The solvent may be an intensified solvent. Optionally, the intensified solvent comprises a tertiary amine, a sterically hindered amine, a polyamine, a salt and water. Optionally, the tertiary amine in the intensified solvent is one or more of: N-methyl-diethanolamine (MDEA) or Triethanolamine (TEA). Optionally, the sterically hindered amines in the intensified solvent are one or more of: 2-amino-2-ethyl-1,3-propanediol (AEPD), 2-amino-2-hydroxymethyl-1,3-propanediol (AHPD) or 2-amino-2-methyl-1-propanol (AMP). Optionally, the polyamine in the intensified solvent is one or more of: 2-piperazine-1-ethylamine (AEP) or 1-(2-hydroxyethyl)piperazine. Optionally, the salt in the intensified solvent is potassium carbonate. Optionally, water (for example, deionised water) is included in the solvent so that the solvent exhibits a single liquid phase. Optionally, the solvent is CDRMax as sold by Carbon Clean Solutions Limited. CDRMax, as sold by Carbon Clean Solutions Limited, has the following formulation: from 15 to 25 weight % 2-amino-2-methyl propanol (CAS number 124-68-5); from 15 to 25 weight % 1-(2-ethylamino)piperazine (CAS number 140-31-8); from 1 to 3 weight % 2-methylamino-2-methyl propanol (CAS number 27646-80-6); from 0.1 to 1 weight % potassium carbonate (584-529-3); and, the balance being deionised water (CAS number 7732-18-5).

### Examples

The following are non-limiting examples that discuss, with reference to tables and figures, the advantages of the present invention. The examples set forth herein are non-limiting examples and are merely examples among other possible examples.

### System 200: Removal of Impurities in a Flue Gas by Using an External Cooling System

According to a first aspect of the present disclosure, there is provided a system and a method for reducing the concentration of impurities in a flue gas. In particular, the method and system reduces the amount of SO₃ in a flue gas (prior to the removal of CO₂) compared to known systems and methods.

Advantageously, the method controls the temperature of the flue gas to prevent the flue gas reaching the dew point of SO₃ in water, thereby reducing the concentration of SO₃ in a flue gas.

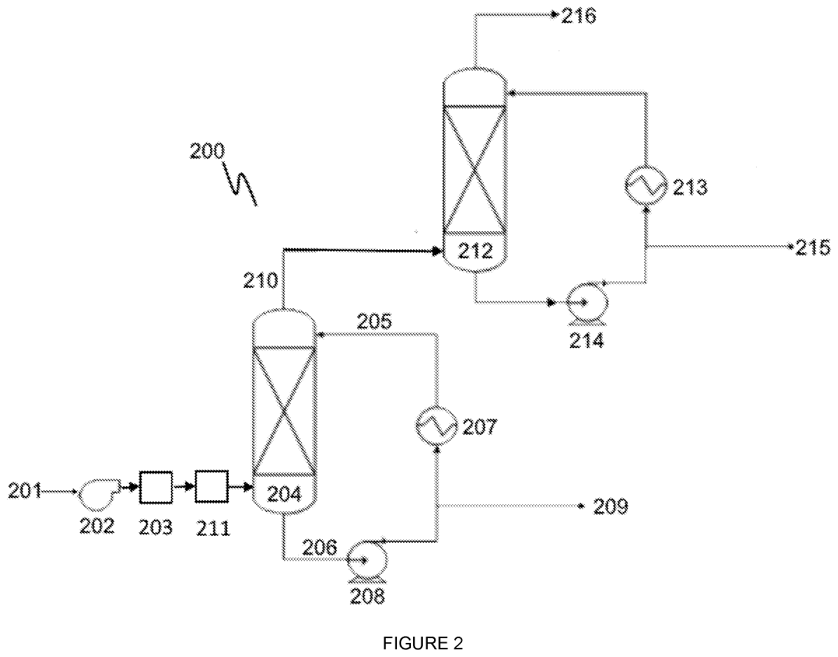

FIG. 2 illustrates a block diagram of a system 200 according to a first aspect of the present invention.

As shown in FIG. 2, a flue gas 201 enters the system 200 at a temperature of from 100 to 230° C., or from 105 to 220° C., or from 110 to 210° C., or from 115 to 200° C., typically at ambient pressure (1 atmosphere).

The flue gas 201 passes through a flue gas blower 202. The flue gas blower 202 increases the pressure of the flue gas 201 to compensate for the pressure drop through the CO₂ removal system (i.e. system 200 and the downstream carbon capture system, not shown), thereby ensuring that the pressure of the flue gas 201 once cooled (cooled flue gas 210) is at the same, or a similar, pressure as the flue gas at the outlet of the downstream carbon capture system (not shown). Typically, the flue gas blower 202 is an induced draft fan provided at the battery limit.

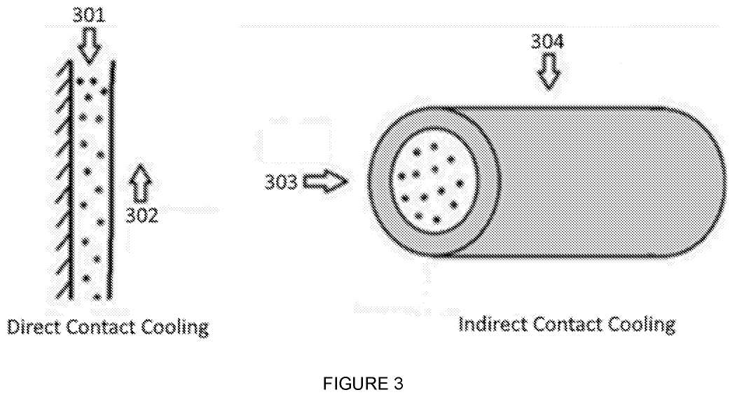

The flue gas 201 then passes through an external cooling system 203 which indirectly cools the flue gas 201. FIG. 3 illustrates the indirect contact cooling mechanism of the external cooling system 203. In direct contact cooling (“Direct Contact Cooling” in FIG. 3), a hot fluid 302 (for example hot flue gas) is cooled by a cooling medium 301 (for example cold water, or, cool air, or, a cool CO₂ capture solvent) flowing in an opposite direction. In direct contact cooling, the hot fluid 302 and the cooling medium 301 come into direct contact, where there is no wall separating the hot fluid 302 and the cooling medium 301. In indirect contact cooling (“Indirect Contact Cooling” in FIG. 3), a hot fluid 303 (for example hot flue gas) is cooled by a cooling medium 304 (for example cool water, or, cool air, or, a cool CO₂ capture solvent) in equipment such as a heat exchanger. Typical heat exchangers include a spiral heat exchanger, a shell and tube heat exchanger, an air cooling heat exchanger, or, a gas-gas heat exchanger. In indirect contact cooling, the hot fluid 303 and the cooling medium 304 do not come into direct contact, there is a wall or a barrier separating the hot fluid 303 and the cooling medium 304.

The external cooling system 203 can be a heat exchanger. Typical heat exchangers are described in detail below.

A spiral heat exchanger comprises two, flat plates wrapped around a mandrel or centre tube, creating two (or more) concentric spiral channels. The channels are seal-welded on alternate sides to provide a sturdy barrier between the fluids (which are the flue gas and the water). Examples of a spiral heat exchanger include an Alfa Laval Spiral Heat Exchanger Type 1 and an Alfa Laval Spiral Heat Exchanger Type 2.

A shell and tube heat exchanger is composed of a “shell” and a “tube”: One fluid flows inside the tubes and the other through the shell. While flowing, the fluids exchange heat, resulting in the cold fluid gaining heat from the hot fluid.

An air cooling heat exchanger comprises a hot fluid flowing through a finned tube. Ambient air passes over the finned tube, which cools the hot fluid. The heat is transferred to the air from the hot fluid, resulting in the fluid becoming cool. The heated air is discharged into the atmosphere.

A gas-gas heat exchanger transfers heat from one gas to another gas. The gas-gas heat exchanger is called a “gas-gas heat exchanger” because gas flows within both the shell and tube side of the heat exchanger.

Within the external cooling system 203, the flue gas 201 is cooled and SO₃ condenses out from the flue gas 201. To increase efficiency, the heat collected from the flue gas 201 by the external cooling system 203 can be used in a solvent regeneration section of the downstream carbon capture system (not shown).

Upon leaving the external cooling system 203, the flue gas 201 is at a temperature of less than 100° C., or preferably less than 95° C.

Once the flue gas 201 has passed through the external cooling system 203, the flue gas 201 then passes through a condensate pot 211. The condensate pot 211 is typically placed before the inlet of a direct cooling tower 204. The condensate pot 211 removes the condensed moisture and acid mist from the external cooling system 203.

Upon leaving the condensate pot 211, the flue gas 201 passes through a direct contact cooling tower 204 to reduce the temperature further to 50° C. or less, or preferably 40° C. In the direct contact cooling tower 204, the flue gas 201 is contacted with cool water 205 (at approximately 40° C.) in a counter-current direction. Any residual heat in the flue gas 201 is transferred to the cool water 205, forming heated water 206. The heated water 206 is recirculated through a cooler 207 to reduce the temperature of the heated water 206 so that the heated water 206 can be converted into cool water 205, ready for re-use in the direct contact cooling tower 204. Water is moved through the direct contact cooling tower 204 and cooler 207 by a pump 208. Non-useable water and any condensed moisture from the flue gas are removed from the cycle by a drain 209.

The level of condensed water in the direct contact cooling tower 204 is controlled via a bleed line (not shown).

The direct contact cooling tower 204 can be a packed bed tower, or, a rotating packed bed.

The water circulating through the direct contact cooling tower 204 and cooler 207 can be demineralised water (DM water).

The cooler 207 cools the heated water 206 by using a cooling medium comprising sea water, or, cooling water from a cooling tower, or, cool air present in the cooler 207.

After cooling in the direct contact cooling tower 204, the flue gas 201 forms cooled flue gas 210. The temperature of the cooled flue gas 210 is: from 25 to 70° C.; or, from 30 to 60° C.; or, from 35 to 55° C.; or, from 37 to 50° C., or at 40° C.

The cooled flue gas 210 then passes to the impurities removal tower 212. The impurities removal tower can be a packed column with at least one bed of structured packing which enables efficient gas-liquid contact. The impurities removal tower 212 can additionally include a cooler 213, a pump 214, filters (not shown), a dosing pump (not shown) and/or a scrubbing solution tank (not shown).

The impurities removal tower 212 can be a packed column, or, a rotating packed bed which enables efficient gas-liquid contact.

A scrubbing solution is prepared in the scrubbing solution tank (not shown), and there can be a line connecting the scrubbing solution tank to the cooler 213. The scrubbing solution contains scrubbing agents which react with, and subsequently remove, impurities in the cooled flue gas 210. The scrubbing solution can be re-circulated through the impurities removal tower 212. Typically, the scrubbing solution comprises caustic soda (NaOH) in water as the scrubbing agent, and is used for removal of SO₂ from flue gases.

The dosing pump (not shown) can be used to make-up the scrubbing solution based on the pH of the scrubbing solution which reduces when the scrubbing solution reacts with the impurities.

Within the impurities removal tower 212, the cooled flue gas 210 is contacted with the scrubbing agents in the scrubbing solution so that the concentration of impurities within the cooled flue gas 210 is reduced to 10 ppmv or less, preferably to 2 ppmv or less.

Upon removal of the impurities, a cooled impurity low flue gas 216 is formed.

Preferably, the temperature of the cooled impurity low flue gas 216 is at a temperature of from 37 to 50° C. and the cooled impurity low flue gas 216 has an acid mist concentration of 0.5 ppmv or less, preferably of 0.1 ppmv or less.

The temperature of the impurities removal tower 212 is maintained by the cooler 213.

The scrubbing solution is moved through the impurities removal tower 212 and the cooler 213 by the pump 214. Any waste created is removed via a line 215 to be sent to an Effluent Treatment Plant (ETP) for treatment before disposal.

The cooled impurity low flue gas 216 then passes to the downstream carbon capture system (not shown) for removal of CO₂.

Whilst in system 200 the direct cooling tower 204 and the impurities removal tower 212 are shown as separate columns, in other aspects of the disclosure the direct cooling tower 204 and the impurities removal tower 212 can both be accommodated in a single column using a liquid collector in between and with two pump arounds.

Advantageously, condensed moisture and therefore condensed SO₃ (acid mist), is removed from the flue gas through use of the external cooling system 203 and condensate pot 211.

Advantageously, through removal of the condensed moisture and condensed SO₃, formation of acid mist is avoided in the impurities removal tower 212 resulting in little or no carryover of mist to the downstream carbon capture system (not shown).

Advantageously, the concentration of impurities in the flue gas is reduced resulting in a decrease in the speed at which the carbon capture solvent is degraded.

Consequently, the present invention reduces the CO₂ capture cost.

Advantageously, the present invention reduces the load on Effluent Treatment Plant (ETP) by separating the steps of cooling the flue gas removing impurities.

Advantageously, the present invention removes the need for expensive post treatment systems for treating the flue gas post removal of the CO₂, and in particular removing acid mist present in the flue gas post removal of the CO₂.

Advantageously, the present invention decreases the solvent make-up.

Advantageously, the present invention decreases the requirement of steam being used in the solvent treatment system due to low solvent degradation in the downstream carbon capture system.

System 400: Removal of Impurities in a Flue Gas by Using a Scrubbing Solution Comprising Sodium Bicarbonate and/or Sodium Carbonate

According to a second aspect of the present disclosure, there is provided a further method and system for reducing the concentration of impurities in a flue gas. In particular, the method and system reduces the amount of SO₂ and/or NO₂ present in a flue gas (prior to the removal of CO₂) compared to known systems and methods.

Advantageously, the method uses a scrubbing solution to reduce the concentration of 802 and/or NO₂ in a flue gas.

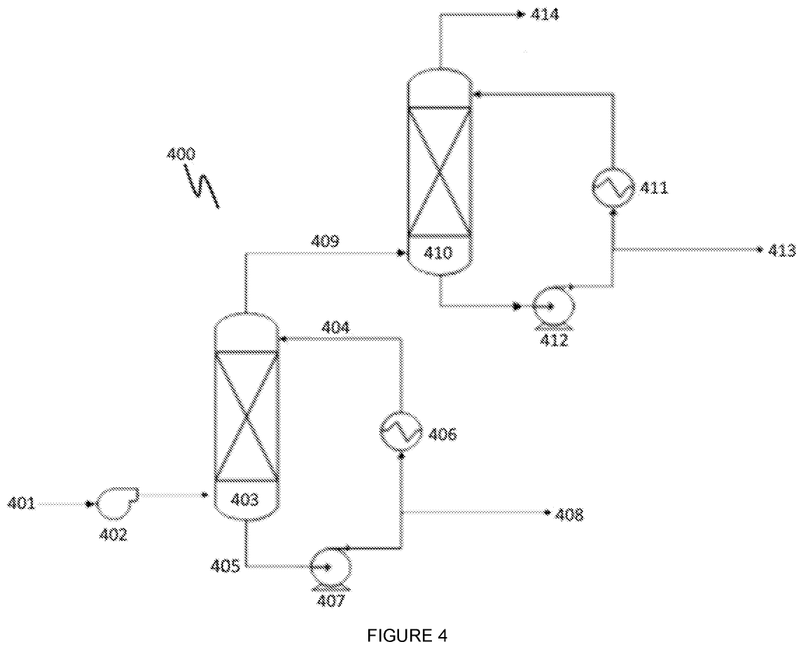

FIG. 4 illustrates a block diagram of a system 400 according to the second aspect of the present invention.

As shown in FIG. 4, a flue gas 401 enters the system 400 at a temperature of from 100 to 230° C., or from 105 to 220° C., or from 110 to 210° C., or from 115 to 200° C., typically at ambient pressure (1 atmosphere).

The flue gas 401 passes through a flue gas blower 402. The flue gas blower 402 increases the pressure of the flue gas 401 to compensate for the pressure drop through the CO₂ removal system (i.e. system 400 and the downstream carbon capture system, not shown), thereby ensuring that the pressure of the flue gas 401 once cooled (cooled flue gas 409) is at the same, or a similar, pressure as the flue gas at the outlet of the downstream carbon capture system (not shown). Typically, the flue gas blower 402 is an induced draft fan provided at the battery limit.

The flue gas 401 then passes through a direct contact cooling tower 403, to reduce the temperature to 50° C. or less, or preferably 40° C. In the direct contact cooling tower 403, the flue gas 401 is contacted with cool water 404 (at approximately 40° C.) in a counter-current direction. Any residual heat in the flue gas 401 is transferred to the cool water 404, forming heated water 405. The heated water 405 is recirculated through a cooler 406 to reduce the temperature of the heated water 405 so that the heated water 405 can be converted into cool water 404, ready for re-use in the direct contact cooling tower 403. Water is moved through the direct contact cooling tower 403 and cooler 406 by a pump 407. Non-useable water and any moisture condensed from the flue gas is removed from the cycle by a drain 408.

The level of condensed water in the direct contact cooling tower 403 is controlled via a bleed line (not shown).

The direct contact cooling tower 403 can be a packed bed tower, or, a rotating packed bed.

The water circulating through the direct contact cooling tower 403 and cooler 406 can be demineralised water (DM water).

The cooler 406 cools the heated water 405 by using a cooling medium comprising sea water, or, cooling water from a cooling tower, or, cool air present in the cooler 406.

After cooling in the direct contact cooling tower 403, the flue gas forms cooled flue gas 409. The temperature of the cooled flue gas 409 is: from 25 to 70° C.; or, from 30 to 60° C.; or, from 35 to 55° C.; or, from 37 to 50° C., or at 40° C.

The cooled flue gas 409 then passes to the impurities removal tower 410. The impurities removal tower 410 can be a packed column with at least one bed of structured packing which enables efficient gas-liquid contact. The impurities removal tower 410 can additionally include a cooler 411, a pump 412, filters (not shown), a dosing pump (not shown) and/or a scrubbing solution tank (not shown).

The impurities removal tower 410 can be a packed column, or, a rotating packed bed which enables efficient gas-liquid contact.

A scrubbing solution is prepared in the scrubbing solution tank (not shown), and can have a line connecting the scrubbing solution tank to the cooler 411. The scrubbing solution contains scrubbing agents which react with, and subsequently remove, impurities in the cooled flue gas 409. The scrubbing solution can be re-circulated through the impurities removal tower 410.

The dosing pump (not shown) can be used to make-up the scrubbing solution based on the pH of the scrubbing solution, which reduces when the scrubbing solution reacts with the impurities.

Within the impurities removal tower 410, the cooled flue gas 409 is contacted with the scrubbing agents in the scrubbing solution.

The temperature of the impurities removal tower 410 is maintained by the cooler 411.

The scrubbing agents are in a solution which circulates in the impurities removal tower 410 and cooler 411 by the pump 412.

The scrubbing agents comprise sodium bicarbonate, or, sodium carbonate, or, sodium bicarbonate and sodium carbonate in an aqueous solution. The concentration of sodium bicarbonate and sodium carbonate in aqueous solution is each: from 0.5 to 10 weight %; or, from 1 to 5 weight %; or, from 1.5 to 4 weight %; the balance being water.

Without wishing to be bound by theory, it is believed that impurities such as SO₂ and NO₂ react with the scrubbing agent to form salts, as follows:

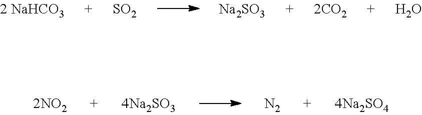

The salts formed increase the electrical conductivity of the solution and are removed from the solution circulating in the impurities removal tower 410 through SO₂ and NO₂ in the cooled flue gas 409 reacting with the salts. A conductivity analyser is used to maintain the concentration of the salts in the scrubbing solution (not shown). The conductivity analyser is placed downstream of the pump 412.

When the cooled flue gas 409 has a high concentration of NO₂, but a low concentration of SO₂, additional Na₂SO₃ is added to the scrubbing solution tank (not shown) to ensure NO₂ is sufficiently removed from the cooled flue gas 409. Typically, when the concentration of NO₂ is higher than 50 ppm, the concentration of NO₂ is considered high. Typically, when the concentration of SO₂ is 5 ppm or below, the concentration of SO₂ is considered low.

Water is added to the circulating scrubbing solution to maintain the salt concentration within limits to avoid precipitation.

Upon removal of the impurities, a cooled impurity low flue gas 414 is formed. Upon leaving the impurities removal tower 410, the cooled impurity low flue gas 414 is at a temperature of from 37 to 50° C. The concentration of impurities within the cooled impurity low flue gas 414 is reduced to 10 ppmv or less, preferably to 2 ppmv or less. Preferably, the cooled impurity low flue gas 414 has a concentration of SO₂ of 10 ppmv or less; preferably, 2 ppmv or less. Preferably, the cooled impurity low flue gas 414 has a concentration of NO₂ of 10 ppmv or less; preferably, 5 ppmv or less. Typically, the cooled impurity low flue gas 414 has a concentration of SO₂ of less than 2 ppmv and a concentration of NO₂ of less than 5 ppmv.

The salts and any waste created are removed via a line 413 to be sent to an Effluent Treatment Plant (ETP) for treatment before disposal.

The cooled, impurity low flue gas 414 then passes to the downstream carbon capture system (not shown) for removal of CO₂.

Whilst in system 400 the direct cooling tower 403 and the impurities removal tower 410 are shown as separate columns, in other aspects of the disclosure the direct cooling tower 403 and the impurities removal tower 410 can both be accommodated in a single column using a liquid collector in between and with two pump arounds. Advantageously, the present invention reduces the release of amine (and other) impurities during the absorption of CO₂ from a flue gas in a downstream carbon capture system. Consequently, the present invention reduces or removes the need for expensive treatment post removal of the CO₂, thereby reducing the CO₂ capture cost.

Advantageously, the present invention reduces the concentration of impurities in the flue gas and therefore decreases the speed at which the solvent used in the absorber is degraded. Consequently, the present invention reduces the CO₂ capture cost.

Advantageously, the present invention reduces the load on Effluent Treatment Plant (ETP) by separating the steps of cooling the flue gas and removing impurities from the flue gas.

Advantageously, the present invention removes the need for expensive post treatment systems for treating the flue gas post removal of the CO₂, and in particular removing aerosols present in the flue gas post removal of the CO₂.

Advantageously, the present invention decreases the solvent make-up.

Advantageously, the present invention decreases the requirement of steam being used in the solvent treatment system due to low solvent degradation in the downstream carbon capture system.

System 500: Removal of Impurities in a Flue Gas by Using an External Cooling System and Removal of Impurities in a Flue as by Using a Scrubbing Solution Comprising Sodium Bicarbonate and/or Sodium Carbonate

According to a third aspect of the present disclosure, there is provided a method and a system of reducing the concentration of impurities in a flue gas. In particular, the method reduces the amount of SO₃, SO₂ and NO₂ present in a flue gas.

In the third aspect of the present disclosure, the methods and systems of systems 200 and 400 of the present disclosure are combined. Advantageously, the system (and associated method) controls the temperature of the flue gas to prevent the flue gas reaching the dew point of SO₃ in water, thereby reducing the concentration of SO₃ in a flue gas and also uses a scrubbing solution to reduce the concentration of SO₂ and/or NO₂ in a flue gas, prior to downstream carbon capture.

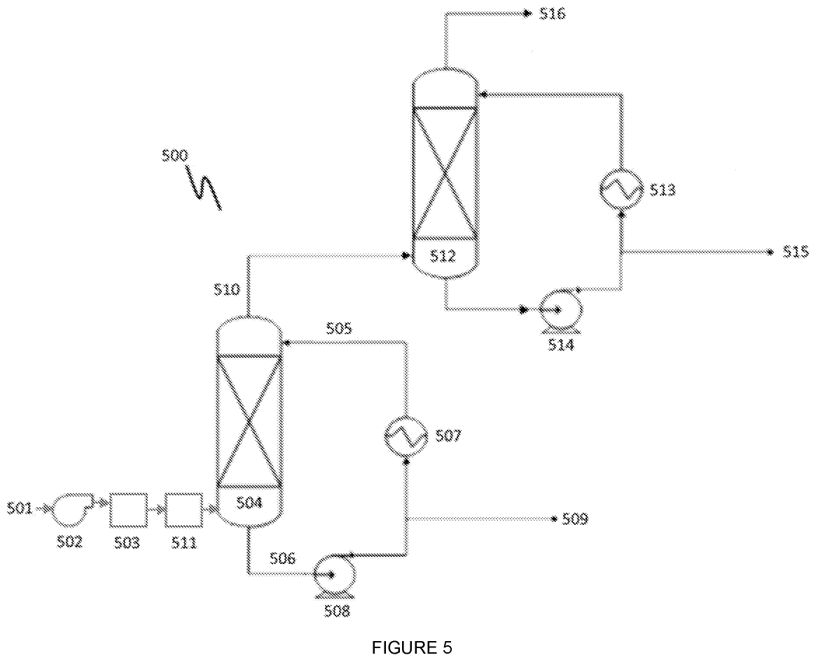

FIG. 5 illustrates a block diagram of a system 500 according to a third aspect of the present invention.

As shown in FIG. 5, a flue gas 501 enters the system 500 at a temperature of from 100 to 230° C., or from 105 to 220° C., or from 110 to 210° C., or from 115 to 200° C. typically at ambient pressure (1 atmosphere).

The flue gas 501 passes through a flue gas blower 502. The flue gas blower 502 increases the pressure of the flue gas 501 to compensate for the pressure drop through the CO₂ removal system (i.e. system 500 and the downstream carbon capture system, not shown), thereby ensuring that the pressure of the flue gas 501 once cooled (cooled flue gas 510) is at the same, or a similar, pressure as the flue gas at the outlet of the downstream carbon capture system (not shown). Typically, the flue gas blower 502 is an induced draft fan provided at the battery limit.

The flue gas 501 then passes through an external cooling system 503 to indirectly cool the flue gas 501.

The external cooling system 503 can be a heat exchanger. Typical heat exchangers used include a spiral heat exchanger, a shell and tube heat exchanger, an air cooled heat exchanger, or, a gas-gas heat exchanger, which are described in detail below.

A spiral heat exchanger is composed of two flat plates wrapped around a mandrel or centre tube, creating two concentric spiral channels. The channels are seal-welded on alternate sides to provide a sturdy barrier between the fluids (which are the flue gas and water). Examples of typical spiral heat exchangers include Alfa Laval Spiral Heat Exchanger Type 1 and Alfa Laval Spiral Heat Exchanger Type 2.

A shell and tube heat exchanger is composed of a “shell” and a “tube”: One fluid flows inside the tubes and the other through the shell. While flowing, the fluids exchange heat, resulting in the cold fluid gaining heat from the hot fluid.

An air cooling heat exchanger has a hot fluid flowing through a finned tube. Ambient air passes over the finned tube, which cools the hot fluid. The heat is transferred to the air from the hot fluid, resulting in the fluid becoming cool. The heated air is discharged into the atmosphere.

A gas-gas heat exchanger transfers heat from one gas to another gas. The gas-gas heat exchanger is called a “gas-gas heat exchanger” because gas is flowing on both the shell and tube side of the heat exchanger.

Within the external cooling system 503, the flue gas 501 is cooled and SO₃ condenses out from the flue gas 501. To increase efficiency, the heat collected from the flue gas 501 by the external cooling system 503 can be used in a solvent regeneration section of the downstream carbon capture system (not shown).

Upon leaving the external cooling system 503, the flue gas 501 is at a temperature of less than 100° C., or less than 95° C.

Once the flue gas 501 has passed through the external cooling system 503, the flue gas 501 then passes through a condensate pot 511. The condensate pot 511 is typically placed at the inlet of a direct cooling tower 504. The condensate pot 511 removes the condensed moisture and acid mist from the external cooling system 503.

Upon leaving the condensate pot 511, the flue gas 501 passes through a direct contact cooling tower 504 to reduce the temperature further to 50° C. or less, or preferably 40° C. In the direct contact cooling tower 504, the flue gas 501 is contacted with cool water 505 (at approximately 40° C.) in a counter-current direction. Any residual heat in the flue gas 501 is transferred to the cool water 505, forming heated water 506. The heated water 506 is recirculated through a cooler 507 to reduce the temperature of the heated water 506 so that the heated water 506 can be converted into cool water 505, ready for re-use in the direct contact cooling tower 504. Water is moved through the direct contact cooling tower 504 and cooler 507 by a pump 508. Non-useable water and any condensed moisture from flue gas are removed from the cycle by a drain 509.

The level of condensed water in the direct contact cooling tower 504 is controlled via a bleed line (not shown).

The direct contact cooling tower 504 can be a packed bed tower, or, a rotating packed bed.

The water circulating through the direct contact cooling tower 504 and cooler 507 can be demineralised water (DM water).

The cooler 507 cools the heated water 506 by using a cooling medium comprising sea water, or, cooling water from a cooling tower, or, cool air present in the cooler 507.

After cooling in the direct contact cooling tower 504, the flue gas 501 forms cooled flue gas 510. The temperature of the cooled flue gas 510 is: from 25 to 70° C.; or, from 30 to 60° C.; or, from 35 to 55° C.; or, from 37 to 50° C., or at 40° C.

The cooled flue gas 510 then passes to the impurities removal tower 512. The impurities removal tower 512 can be a packed column with at least one bed of structured packing which enables efficient gas-liquid contact. The impurities removal tower 512 can additionally include a cooler 513, a pump 514, filters (not shown), a dosing pump (not shown) and/or a scrubbing solution tank (not shown).

The impurities removal tower 512 can be a packed column, or, a rotating packed bed which enables efficient gas-liquid contact.

A scrubbing solution is prepared in the scrubbing solution tank (not shown), and can have a line connecting the scrubbing solution tank to the cooler 513. The scrubbing solution contains scrubbing agents that react with, and subsequently remove, impurities in the cooled flue gas 510. The scrubbing solution can be re-circulated through the impurities removal tower 512.

The dosing pump (not shown) can be used to make-up the scrubbing solution based on the pH of the scrubbing solution which reduces when the scrubbing solution reacts with the impurities.

Within the impurities removal tower 512, the cooled flue gas 510 is contacted with scrubbing agents in the scrubbing solution.

The temperature of the impurities removal tower 512 is maintained by the cooler 513.

The scrubbing solution circulates in the impurities removal tower 512 and cooler 513 by the pump 514.

The scrubbing agents comprise sodium bicarbonate, or, sodium carbonate, or, sodium bicarbonate and sodium carbonate in an aqueous solution. The concentration of sodium bicarbonate and sodium carbonate in aqueous solution is each: from 0.5 to 10 weight %; or, from 1 to 5 weight %; or, from 1.5 to 4 weight %; the balance being water.

Without wishing to be bound by theory, it is believed that impurities such as SO₂ and NO₂ react with the scrubbing agent to form salts, as follows:

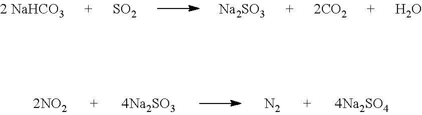

The salts formed increase the electrical conductivity of the solution and are removed from the solution circulating in the impurities removal tower 512 through SO₂ and NO₂ in the cooled flue gas 510 reacting with the salts. A conductivity analyser is used to maintain the concentration of the salts in the scrubbing solution (not shown). The conductivity analyser is placed downstream of the pump 514.

When the cooled flue gas 510 has a high concentration of NO₂, but a low concentration of SO₂, additional Na₂SO₃ is added to the scrubbing solution tank (not shown) to ensure NO₂ is sufficiently removed from the flue gas. Typically, when the concentration of NO₂ is higher than 50 ppm, the concentration of NO₂ is considered high. Typically, when the concentration of SO₂ is 5 ppm or below, the concentration of SO₂ is considered low.

Water is added to the circulating scrubbing solution to maintain the salt concentration within limits to avoid precipitation.

Upon removal of the impurities, a cooled impurity low flue gas 516 is formed. Upon leaving the impurities removal tower 512, the cooled impurity low flue gas 516 is at a temperature of from 37 to 50° C. The concentration of impurities within the cooled impurity low flue gas 516 is reduced to 10 ppmv or less, preferably to 2 ppmv or less. Preferably, the cooled impurity low flue gas 516 has a concentration of SO₂ of from 10 ppmv or less, preferably from 2 ppmv or less, a concentration of NO₂ of from 10 ppmv or less, preferably from 5 ppmv or less and an acid mist concentration of from 0.5 ppmv or less, preferably from 0.1 ppmv or less.

The salts and any waste created is/are removed via a line 515 to be sent to an Effluent Treatment Plant (ETP) for treatment before disposal.

The cooled, impurity low flue gas 516 then passes to the downstream carbon capture system (not shown) for removal of CO₂.

Whilst in system 500 the direct cooling tower 504 and the impurities removal tower 512 are shown as separate columns, in other aspects of the disclosure the direct cooling tower 504 and the impurities removal tower 512 can both be accommodated in a single column using a liquid collector in between and with two pump arounds. Advantageously, condensed moisture and therefore condensed SO₃ (acid mist) is removed from the flue gas through use of the external cooling system 503 and condensate pot 511.

Advantageously, the present invention reduces the release of amine (and other) impurities during the absorption of CO₂ from a flue gas. Consequently, the present invention reduces or removes the need for expensive treatment post removal of the CO₂, thereby reducing the CO₂ capture cost.

Advantageously, the present invention reduces the release of impurities in the flue gas and therefore decreases the speed at which the solvent used in the absorber is degraded. Consequently, the present invention reduces the CO₂ capture cost.

Advantageously, the present invention reduces the load on Effluent Treatment Plant (ETP) by separating the steps of cooling the flue gas and removing impurities.

Advantageously, the present invention removes the need for expensive post treatment systems for treating the flue gas post removal of the CO₂, and in particular removing aerosols present in the flue gas post removal of the CO₂.

Advantageously, the present invention decreases the solvent make-up.

Advantageously, the present invention decreases the requirement of steam being used in the solvent treatment system due to low solvent degradation of a downstream carbon capture solvent.

### Dew-Point Temperature Versus Concentration

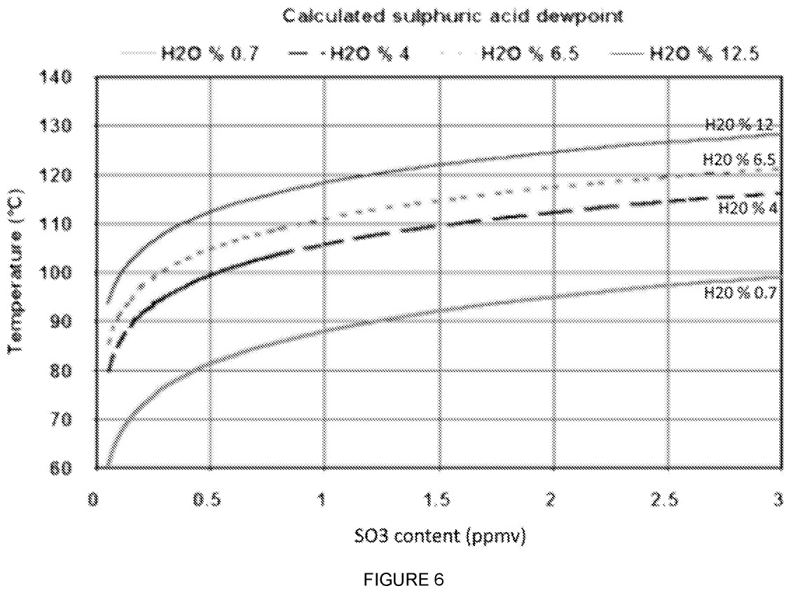

The dew point temperature of SO₃ (° C.) as a function of SO₃ concentration (ppmv) and moisture content of the flue gas was measured for four flue gases comprising different water volume % content. The water content of each flue gas tested (and tabulated in FIG. 6) was: 0.7 volume %; 4 volume %; 6.5 volume %; and, 12 volume %.

FIG. 6 plots the measured dew point temperature of SO₃ (in ° C.) as a function of SO₃ concentration (in parts per million by volume (ppmv)) for each flue gas. Below each plotted line, the SO₃ forms acid mist: above each plotted line no acid mist forms.

FIG. 6 shows that to ensure limited or no acid mist is present in a flue gas, the concentration of SO₃ is preferably less than 0.5 ppmv, or even more preferably less than 0.1 ppmv.

To achieve this, the present inventors discovered that the flue gas should be indirectly cooled to below the corresponding dew point for the condensation of acid mist though cooling the flue gas to less than 105° C., or less than 100° C., or less than 95° C., by indirect cooling (for example, using systems 200 or 500) prior to further treatment and/or direct cooling. The acid mist formed is thereby reduced to below 0.1 ppmv.

By contrast, if only direct cooling is used (as in the prior art system 100), the SO₃ dew point is reached but acid mist (being of nanometre size) would escape with the flue gas to the downstream carbon capture plant. In the prior art systems such as 100, due to the direct contact between components in the flue gas with water acid mist forms.

### Emission of Solvent Due to Acid Mist Present in the Flue Gas

As described under “Background”, an acid mist can severely affect the emissions in a carbon capture system. If acid mist enters a carbon dioxide absorber, the acid mist will be able to carry the carbon capture solvent out of the absorber because conventional water wash systems cannot retain the solvent, owing to the nanometre size of the mist. The carbon capture solvent is then lost to the atmosphere (and adds to overall pollution). Therefore, one way to monitor whether acid mist enter a downstream carbon capture system is to monitor the emission of solvent in a carbon dioxide depleted flue gas leaving a downstream carbon capture system.

In this example, the concentration of solvent in a flue gas in the form of acid mist is measured using iso-kinetic sampling and acid titration to determine the solvent loss from the system.

In this example, the solvent CDRMax® (as sold by Carbon Clean Solutions Limited) was used. The solvent includes amines.

The emissions of amines, as represented by the presence of the solvent CDRMax®, was measured by using isokinetic sampling to determine the amount of amine (and consequently the amount of acid mist) that was emitted.

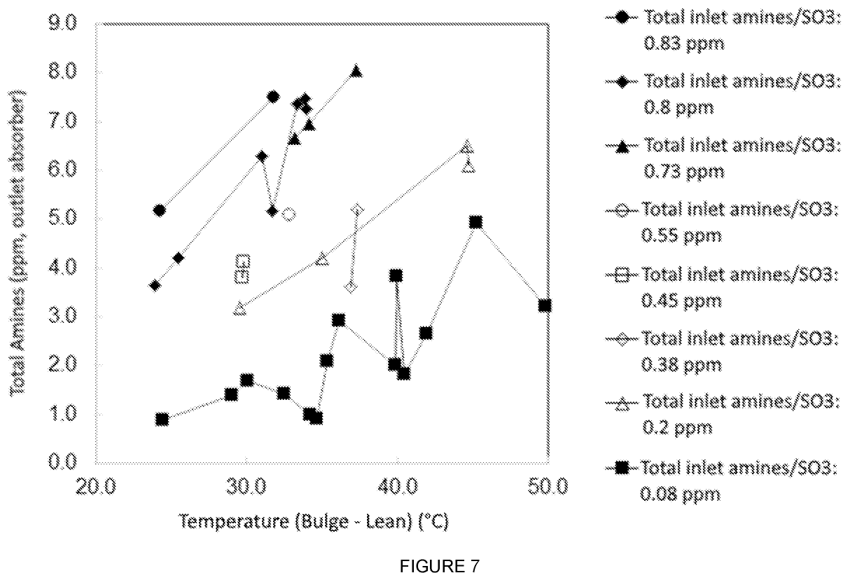

The relationship between the acid mist concentration, maximum temperature in the absorber (the higher the temperature, the higher the carry-over of solvent by the acid mist) and amine emissions is shown in FIG. 7.

Each value was measured by iso-kinetic sampling and acid titration and is reported in ppm.

FIG. 7 shows that as the concentration of SO₃ present in the flue gas increases, so does the concentration of solvent present in the flue gas emitted. Therefore, by using the indirect cooling aspects of the presently claimed methods and systems, the amount of SO₃ and carbon capture solvent present in flue gases emitted from a carbon capture system is minimised. Therefore, less solvent is lost and carbon capture efficiency is improved.

Removal of NO₂/SO₂ by a Scrubbing Solution Comprising Sodium Bicarbonate and Sodium Carbonate

The removal of NO₂ and SO₂ from a carbon rich flue gas by using sodium bicarbonate and sodium carbonate in a solution was measured.

In the solution, sodium bicarbonate was present at 3 weight % and sodium carbonate was present at 2 weight % in water. With reference to FIG. 4, this scrubbing solution would be included in the impurities removal tower 410. With reference to FIG. 5, this scrubbing solution would be included in the impurities removal tower 512.

The concentration of NO₂ and SO₂ in a carbon dioxide rich flue gas was measured before passing through a scrubbing solution comprising sodium bicarbonate and sodium carbonate at a pressure of approximately 1 atmosphere and a temperature of from 37 to 50° C. The results are shown in Table 1, below.

TABLE 1
Results of the removal of NO₂ and SO₂ from a carbon
rich flue gas by passing through sodium bicarbonate
and sodium carbonate in a solution.

| | Inlet concentration | Outlet concentration |
|---|---|---|
| NO₂ | 10 ppm | <5 ppm |
| SO₂ | 100 ppm | <2 ppm |

As shown in Table 1, upon using a scrubbing solution comprising sodium bicarbonate at 3 weight %, sodium carbonate at 2 weight %, the balance being water, the concentration of NO₂ and SO₂ in the flue gas is reduced considerably.

Advantageously, through reducing the concentration of NO₂ and SO₂ in the flue gas, degradation of the carbon capture solvent is minimised. Minimal degradation of the carbon capture solvent prolongs the life of the carbon capture solvent resulting in a reduction in operating costs.

The present invention is not limited to flue gases produced from power plants or from process gases produced from various industrial processes including steelworks, cement kilns, calciners or smelters, but can be applied to any CO₂ rich gas containing impurities.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A process of capturing carbon dioxide (CO₂) from flue gases, the process comprising the steps of:
(i) indirectly cooling a flue gas comprising carbon dioxide (CO₂), the flue gas having a starting temperature of from 115° C. to 200° C., to form a cooled flue gas having a cooled temperature of less than 95° C.;
(ii) indirectly or directly further cooling the cooled flue gas to between 37° C. and 50° C. to form a further cooled flue gas; prior to,
(iii) contacting the further cooled flue gas with a carbon capture solvent such that the carbon capture solvent removes carbon dioxide (CO₂) from the cooled flue gas.

2. The process of claim 1, wherein the step of (i) indirectly cooling occurs in a heat exchanger.

3. The process of claim 1, wherein the step of (i) indirectly cooling occurs in:
a spiral heat exchanger,
a shell and tube heat exchanger,
an air cooled heat exchanger, and/or,
a gas-gas heat exchanger.

4. The process of claim 1, wherein the step of (ii) indirectly further cooling occurs in a heat exchanger;
optionally wherein the heat exchanger comprises a spiral heat exchanger, a shell and tube heat exchanger, an air cooled heat exchanger, and/or, a gas-gas heat exchanger.

5. (canceled)

6. The process of claim 1, wherein the step of (ii) directly further cooling occurs in a direct contact cooling tower.

7. The process of claim 1, wherein the process further comprises the steps of:
(iv) contacting a flue gas comprising carbon dioxide (CO₂) with a scrubbing agent, thereby removing SO₂ and NO₂ from the flue gas, to form a scrubbed flue gas; prior to,
(v) contacting the scrubbed flue gas comprising carbon dioxide (CO₂) with a carbon capture solvent such that the carbon capture solvent absorbs carbon dioxide (CO₂) from the scrubbed flue gas;
wherein the scrubbing agent comprises: sodium bicarbonate; or, sodium carbonate; or, sodium bicarbonate and sodium carbonate.

8. A system for capturing carbon dioxide (CO₂) from flue gases, the system comprising:
(i) an indirect contact cooler for cooling a flue gas comprising carbon dioxide (CO₂), the flue gas having a starting temperature of from 115° C. to 200° C., to form a cooled flue gas having a cooled temperature of less than 95° C.;
(ii) a cooler for indirectly or directly further cooling the cooled flue gas to between 37° C. and 50° C. to form a further cooled flue gas; and
(iii) a carbon capture system for contacting the further cooled flue gas with a carbon capture solvent such that the carbon capture solvent removes carbon dioxide (CO₂) from the cooled flue gas.

9. The system of claim 8, wherein the indirect contact cooler (i) is a heat exchanger.

10. The system of claim 8, wherein the indirect contact cooler (i) is:
a spiral heat exchanger,
a shell and tube heat exchanger,
an air cooled heat exchanger, and/or,
a gas-gas heat exchanger.

11. The system of claim 8, wherein cooler (ii) is a heat exchanger;
optionally wherein the heat exchanger comprises a spiral heat exchanger, a shell and tube heat exchanger, an air cooled heat exchanger, and/or, a gas-gas heat exchanger.

12. (canceled)

13. The system of claim 8, wherein the cooler (ii) is a direct contact cooling tower.

14. The system of claim 8, wherein the system further comprises:
(iv) an impurities removal tower comprising a scrubbing solution for contacting a flue gas comprising carbon dioxide (CO₂) with a scrubbing agent, thereby removing SO₂ and NO₂ from the flue gas, to form a scrubbed flue gas; prior to,
(v) a carbon capture system for contacting the scrubbed flue gas comprising carbon dioxide (CO₂) with a carbon capture solvent such that the carbon capture solvent absorbs carbon dioxide (CO₂) from the scrubbed flue gas;
wherein the scrubbing agent comprises: sodium bicarbonate; or, sodium carbonate; or, sodium bicarbonate and sodium carbonate.

15. A process of capturing carbon dioxide (CO₂) from flue gases, the process comprising the steps of:
(i) contacting a flue gas comprising carbon dioxide (CO₂) with a scrubbing agent, thereby removing SO₂ and NO₂ from the flue gas, to form a scrubbed flue gas; prior to,
(ii) contacting the scrubbed flue gas comprising carbon dioxide (CO₂) with a carbon capture solvent such that the carbon capture solvent absorbs carbon dioxide (CO₂) from the scrubbed flue gas;
wherein the scrubbing agent comprises: sodium bicarbonate; or, sodium carbonate; or, sodium bicarbonate and sodium carbonate.

16. The process of claim 15, wherein: the sodium bicarbonate; or, the sodium carbonate; or, the sodium bicarbonate and sodium carbonate; is/are present in from 2% by weight to 10% by weight in the scrubbing agent.

17. The process of claim 15, wherein the process further comprises the steps of:
(iii) indirectly cooling a flue gas comprising carbon dioxide (CO₂), the flue gas having a starting temperature of from 200° C. to 115° C., to form a cooled flue gas having a cooled temperature of less than 95° C.;
(iv) indirectly or directly further cooling the cooled flue gas to between 37° C. and 50° C. to form a further cooled flue gas; prior to,
(v) contacting the further cooled flue gas with a carbon capture solvent such that the carbon capture solvent absorbs carbon dioxide (CO₂) from the cooled flue gas.

18. A system for capturing carbon dioxide (CO₂) from flue gases, the system comprising:
(i) an impurities removal tower comprising a scrubbing solution for contacting a flue gas comprising carbon dioxide (CO₂) with a scrubbing agent, thereby removing SO₂ and NO₂ from the flue gas, to form a scrubbed flue gas; prior to,
(ii) a carbon capture system for contacting the scrubbed flue gas comprising carbon dioxide (CO₂) with a carbon capture solvent such that the carbon capture solvent absorbs carbon dioxide (CO₂) from the scrubbed flue gas;
wherein the scrubbing agent comprises: sodium bicarbonate; or, sodium carbonate; or, sodium bicarbonate and sodium carbonate.

19. The system of claim 18, wherein the sodium bicarbonate; or, the sodium carbonate; or, the sodium bicarbonate and sodium carbonate; is/are present in from 2% by weight to 10% by weight in the scrubbing agent.

20. A scrubbing agent for removing NO₂, SO₂, or NO₂ and SO₂, from a flue gas, the scrubbing agent comprising:
sodium bicarbonate;
sodium carbonate; and,
water.

21. The scrubbing agent of claim 20, wherein the scrubbing agent comprises (in weight %):
(a) from 0.5 to 10.0 sodium bicarbonate; from 0.5 to 10.0 sodium carbonate; and from 99.0 to 80.0 water;
(b) from 1.0 to 5.0 sodium bicarbonate; from 1.0 to 5.0 sodium carbonate; and from 98.0 to 90.0 water; and/or
(c) from 1.0 to 3.0 sodium bicarbonate; from 1.0 to 2.0 sodium carbonate; and from 98.0 to 95.0 water.

22. (canceled)

23. (canceled)

24. Use of the scrubbing agent of claim 20 in a process of capturing carbon dioxide (CO₂) from flue gases.
